(19) United States
(12) Patent Application Publication
(10) Pub. No.: US 2023/0389123 A1
(43) Pub. Date: Nov. 30, 2023

(54) COMMUNICATION APPARATUSES AND COMMUNICATION METHODS FOR SIDELINK BROADCAST

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng, Michael SIM, Singapore (SG); Xuan Tuong TRAN, Singapore (SG)

(21) Appl. No.: 18/249,513

(22) PCT Filed: Jul. 15, 2021
(86) PCT No.: PCT/SG2021/050414

§ 371 Date: Apr. 18, 2023

(30) Foreign Application Priority Data
Oct. 22, 2020 (SG) 10202010497R

(51) Int. Cl. H04W 76/28; H04W 52/02

(52) U.S. Cl. CPC H04W 76/28; H04W 52/0216

(57) ABSTRACT

The present disclosure provides communication apparatuses and communication methods for V2X broadcast. The communication apparatuses include a communication apparatus comprising: circuitry, which in operation, determines a periodic transmission time interval to transmit a first signal; and a transmitter, which in operation, transmits the first signal at the periodic transmission time interval in response to the determination.

### TECHNICAL FIELD

The following disclosure relates to communication apparatuses and communication methods for New Radio (NR) communications, and more particularly to communication apparatuses and communication methods for sidelink broadcast.

### BACKGROUND

Vehicle-to-everything (V2X) communication allows vehicles to interact with public roads and other road users, and is thus considered a critical factor in making autonomous vehicles a reality.

To accelerate this process, 5G new radio access technology (NR) based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink (SL) with other nearby vehicles, infrastructure nodes and/or pedestrians. The status information includes information on position, speed, heading, etc.

According to identification in Release 17 (Rel-17) NR SL enhancement Work Item Description (WID) (RP-201385), power saving enables UEs with battery constraint to perform SL operations in a power efficient manner. Rel-16 NR sidelink is designed based on the assumption of “always-on” when UE operates SL, e.g. only focusing on UEs installed in vehicles with sufficient battery capacity. Therefore, solutions for power saving in Rel-17 are required for vulnerable road users (VRUs) in V2X use cases and for UEs in public safety and commercial use cases where power consumption in the UEs needs to be minimized.

For safety concern of VRUs, the most fundamental step is based on the detection of the VRU presence. From a radio communication perspective, a broadcast signal (e.g. safety message broadcast) to indicate VRU's presence would be necessary to alert vehicle UEs (V-UEs) such that the V-UEs can take caution of the VRU.

In particular, it is not clear when vulnerable road users UEs (VRU-UE) should transmit its broadcast signal/message to indicate its presence. Further, there is no discussion about utilizing the Discontinuous Reception (DRX) feature to transmit a VRU's broadcast signal/message to indicate its presence.

Hence, there is a need to address one or more of the above challenges and develop new communication apparatuses and communication methods for V2X broadcast. Furthermore, other desirable features and characteristics will become apparent from the subsequent detailed description and the appended claims, taken in conjunction with the accompanying drawings and this background of the disclosure.

### SUMMARY

One non-limiting and exemplary embodiment facilitates providing communication apparatuses and methods for utilisation of SL-RSRP in V2X resource sensing & selection.

In a first aspect, the present disclosure provides a communication apparatus comprising: circuitry, which in operation, determines a periodic transmission time interval to transmit a first signal; and a transmitter, which in operation, transmits the first signal at the periodic transmission time interval in response to the determination.

In a second aspect, the present disclosure provides a communication method comprising: determining a periodic transmission time interval to transmit a first signal; and transmitting the first signal at the periodic transmission time interval in response to the determination.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for radio resource control (RRC) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 shows a schematic example of communication apparatus in accordance with various embodiments. The communication apparatus may be implemented as an UE or a gNB/base station and configured for vulnerable road users to transmit a first signal at a periodic transmission time interval in accordance with various embodiments of the present disclosure.

FIG. 7 shows a flow diagram illustrating a communication method for vulnerable road users to transmit a first signal at a periodic transmission time interval in accordance with various embodiments of the present disclosure.

FIG. 8 depicts example geographical zone based resources.

FIG. 9 depicts an example time diagram illustrating a listen-before-talk (LBT) period of a VRU-UE.

FIG. 10 depicts another example time diagram illustrating an LBT period of a VRU-UE.

FIG. 11 illustrates a map of a road junction, two roads forming the road junction and geographical zones 1106-1120 adjacent to the two roads according to an embodiment.

FIG. 12 depicts an example time resource pool of a VRU-UE in relation to its DRX cycles.

FIG. 13A depicts an example receive (Rx) resource pool of a VRU-UE in relation to a transmission (Tx) resource pool of a V-UE.

FIG. 13B depicts an example Tx resource pool of a VRU-UE in relation to a Rx resource pool of a V-UE.

FIGS. 14A and 14B depict two configurations allocating a SL Rx duration and a SL Tx duration within a DRX on-duration according to an embodiment of the present disclosure.

FIGS. 15A and 15B depicts two configurations allocating a SL Rx duration and a SL Tx duration within a DRX on-duration according to another embodiment of the present disclosure.

FIG. 16 depicts a configuration allocating only a SL Tx duration within a DRX on-duration according to yet another embodiment of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones. The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

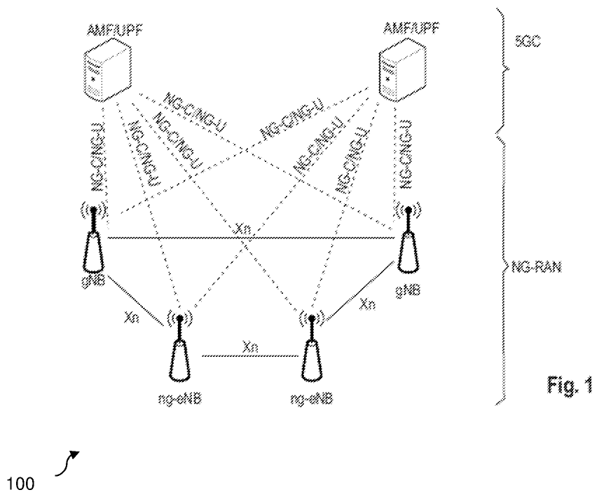

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH(Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PSFCH) for sidelink (SL).

SL supports UE-to-UE direct communication using the SL resource allocation modes, physical layer signals/channels, and physical layer procedures. Two SL resource allocation mode are supported: (a) mode 1, where the SL resource allocation is provided by the network; and (b) mode 2, where UE decides SL transmission resource in the resource pool(s).

PSCCH indicates resource and other transmission parameters used by a UE for PSSCH. PSCCH transmission is associated with a cubic metric reference signal (CM-RS). PSSCH transmits the transport blocks (TBs) of data themselves, and control information for HARQ procedure and channel state information (CSI) feedback triggers, etc. At least 6 Orthogonal Frequency Division Multiplex (OFDM) symbols within a slot are used for PSSCH transmission. PSSCH transmission is associated with a CM-RS and may be associated with a phase-tracking reference signal (PT-RS).

PSFCH carries HARQ feedback over the SL from a UE which is an intended recipient of a PSSCH transmission to the UE which performed the transmission. PSFCH sequence is transmitted in one PRB repeated over two OFDM symbols near the end of the SL resource in a slot.

The SL synchronization signal consists of sL primary and SL secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated demodulation reference signal (DM-RS).

Regarding physical layer procedure for HARQ feedback for sidelink, SL HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In SL resource allocation mode 1, a UE which received PSFCH can report SL HARQ feedback to gNB via PUCCH or PUSCH.

Regarding physical layer procedure for power control for sidelink, for in-coverage operation, the power spectral density of the SL transmissions can be adjusted based on the pathloss from the gNB; whereas for unicast, the power spectral density of some SL transmissions can be adjusted based on the pathloss between the two communicating UEs.

Regarding physical layer procedure for CSI report, for unicast, channel state information reference signal (CSI-RS) is supported for CSI measurement and reporting in sidelink. A CSI report is carried in a SL MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

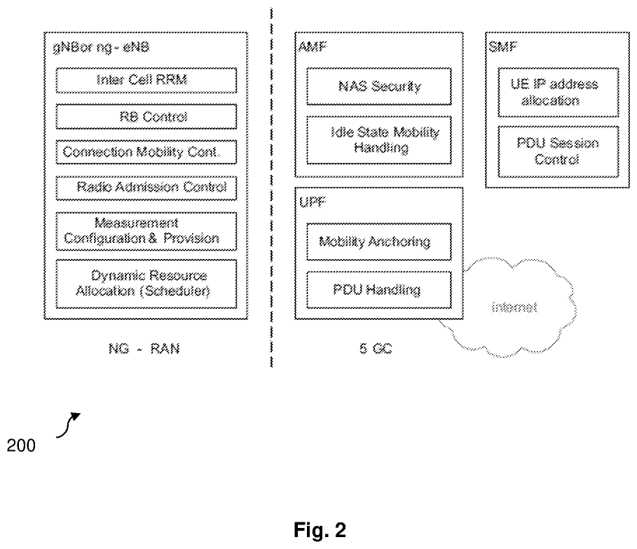

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

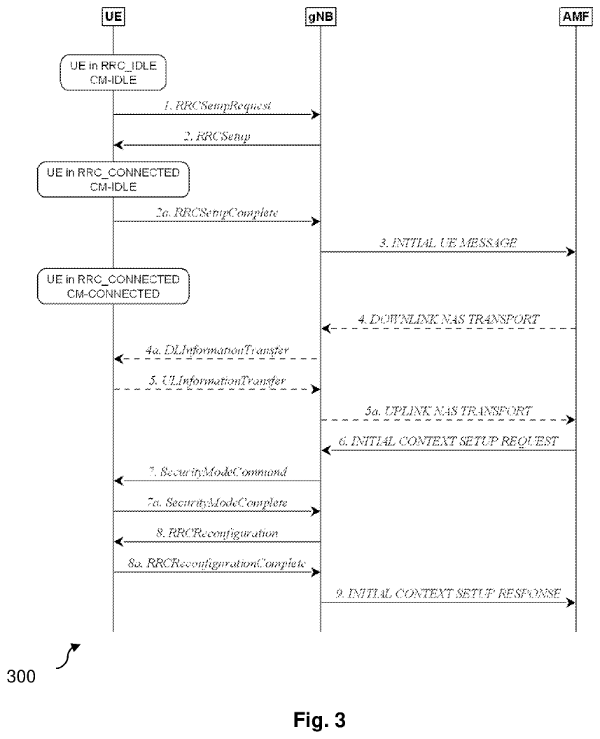

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

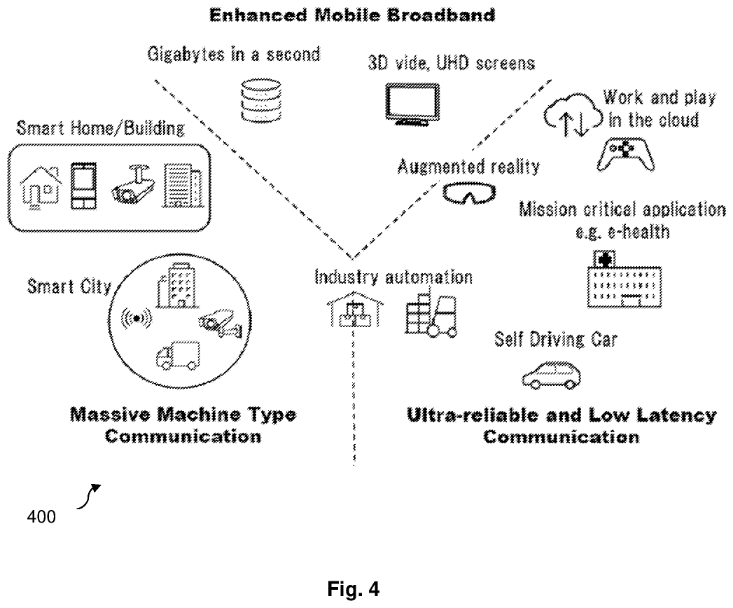

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQ tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

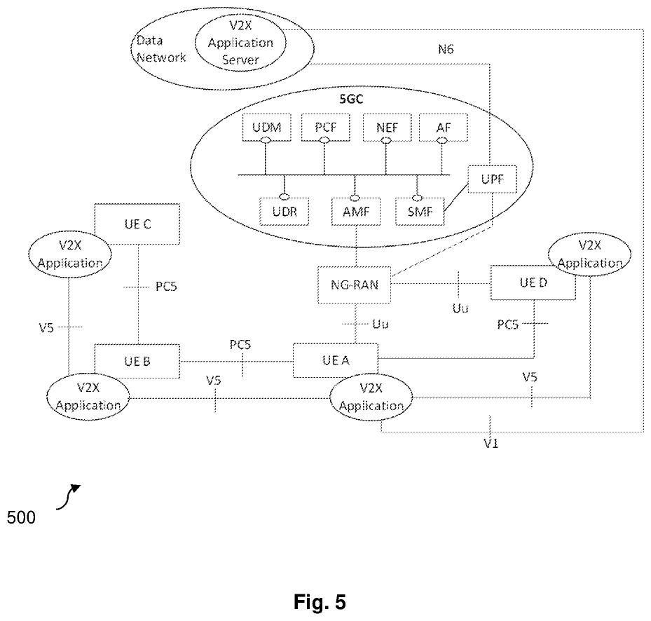

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

According to European Telecommunication Standards Institute (ETSI) technical report (TR) 103 300, the abstracted flow from V2X use cases for vulnerable road users (VRUs) includes:
1. Detection of the VRU presence. The alternatives are:
   VRU self-positioning, where the VRU has sensors and potentially other sources allowing it to determine its own properties, including its location and velocity;
   another road user (e.g. a V-ITS-S) detects and tracks the VRU; and
   roadside equipment connected to an R-ITS-S or a central ITS-S detects and tracks the VRU.
2. Evaluation whether the VRU is at potential risk from other road users and VRU position and dynamic state should be transmitted. Any party may transmit information about VRUs that it is aware of. Information on VRUs should be filtered and only be transmitted according to the message triggering conditions. The potential risk from other road users depends on the following conditions, among others:
   road layout;
   dynamic state of the VRU and the other road users; and
   traffic signal status for both VRU and vehicles, if relevant, and compliance to traffic lights.
3. Evaluation of safety message environment, specifically whether the VRU is part of a cluster, to determine whether the VRU's own ITS-S should transmit.
4. Transmission of information about VRU at-risk. Alternatives are as follows:
   VRU sends ego-status information;
   VRU cluster leader sends cluster information; and
   V-ITS-S, R-ITS-S, C-ITS-S or another road user sends information about a VRU in a potential risk situation.
5. Risk assessment. Phases (receiver side) include:
   fusion of sensor data, and observed information transmitted by other road users to build a local dynamic map, with information about road users' location, velocity and potentially other data, e.g. intention; and
   assessment of risk based on estimated trajectory and velocity of different road users.
6. Warning or action to protect the VRU, including:
   warning of the device carrier (VRU or any other road user); transmission of collision warning to other road users; and
   action in the case of an automated vehicle.

As mentioned earlier, for the safety concern of VRUs, the most fundamental step is the Detection of the VRU presence. It is not clear when a VRU-UE should transmit its SL broadcast signal and security message to indicate its presence. It is further noted that, in LTE and NR uplink and downlink (Uu), DRX is used for power saving purpose. A VRU-UE only needs to wake up DRX on-duration to monitor possible PDCCHs and perform potential transmission. On this basis, a UE with SL capability should utilize DRX features as much as possible to reduce wake-up times for power saving purposes.

In various embodiments below, the following type of road users are considered as vulnerable road users (VRU) according to ETSI TR 103 300 and also the classification in Annex 1 of Regulation (EU) 168/2013 [i.8]:
Pedestrians (including children, elderly, joggers).
Emergency responders, safety workers, road workers.
Animals such as horses, dogs down to relevant wild animals (see note below).
Wheelchairs users, prams.
Skaters, Skateboards, Segway, potentially equipped with an electric engine.
Bikes and e-bikes with speed limited to 25 km/h (e-bikes, class L1 e-A [i.8]).
High speed e-bikes speed higher than 25 km/h, class L1e-B [i.8].
Powered Two Wheelers (PTW), mopeds (scooters), class L1e [i.8].
PTW, motorcycles, class L3e [i.8];
PTW, tricycles, class L2e, L4e and L5e [i.8] limited to 45 km/h;
PTW, quadricycles, class L5e and L6e [i.8] limited to 45 km/h.
NOTE: Relevant wild animals are only those which present a safety risk to other road users (VRUs, vehicles)

In various embodiments below, a communication apparatus may refer to a VRU-UE. A first signal may refer to a SL broadcast signal (e.g. security message) transmitted by the communication apparatus or the VRU-UE to indicate its presence.

In various embodiments below, a periodic transmission time interval may relate to a time interval between each broadcast cycle at which the communication apparatus broadcast (or transmit) the first signal (e.g. SL broadcast signal) periodically.

In various embodiments below, a first periodicity of the periodic transmission time interval refers to a broadcast (transmission) periodicity and a recurrence of the occasions of broadcasting (or transmitting) the first signal.

In various embodiments below, an operating cycle may refer to a DRX cycle (e.g. shortDRX-Cycle or longDRX-cycle) which is a periodic configuration of a DRX period. An operating cycle comprises an active time period during which the communication apparatus is active, e.g. DRX on-duration, and an inactive time period during which the communication apparatus is inactive, e.g. DRX off-duration. In an embodiment, an operating cycle is a longDRX-Cycle of 1280 milliseconds (ms).

In various embodiments below, a second periodicity may be described as a periodicity or a recurrence of the DRX cycle (and the active/inactive time period) of the communication apparatus.

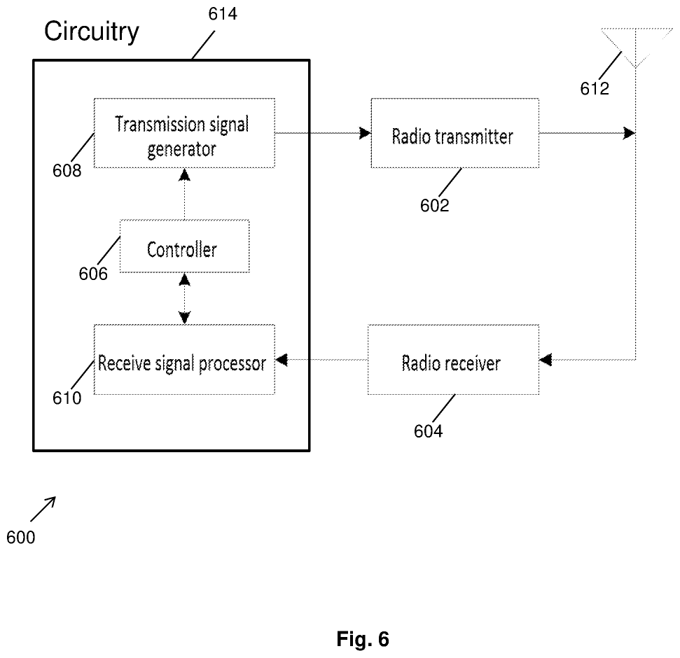

As shown in FIG. 6, the communication apparatus 600 may include circuitry 614, at least one radio transmitter 602, at least one radio receiver 604, and at least one antenna 612 (for the sake of simplicity, only one antenna is depicted in FIG. 6 for illustration purposes). The circuitry 614 may include at least one controller 606 for use in software and hardware aided execution of tasks that the at least one controller 606 is designed to perform, including control of communications with one or more other communication apparatuses in a wireless network. The circuitry 614 may furthermore include at least one transmission signal generator 608 and at least one receive signal processor 610. The at least one controller 606 may control the at least one transmission signal generator 608 for generating signals (for example, a broadcast signal) to be sent through the at least one radio transmitter 602 to one or more other communication apparatuses (e.g. peer communication apparatuses) and the at least one receive signal processor 610 for processing signals (for example, a broadcast signal) received through the at least one radio receiver 604 from the one or more other communication apparatuses under the control of the at least one controller 606. The at least one transmission signal generator 608 and the at least one receive signal processor 610 may be stand-alone modules of the communication apparatus 600 that communicate with the at least one controller 606 for the above-mentioned functions, as shown in FIG. 6. Alternatively, the at least one transmission signal generator 608 and the at least one receive signal processor 610 may be included in the at least one controller 606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 602, at least one radio receiver 604, and at least one antenna 612 may be controlled by the at least one controller 606.

The communication apparatus 600, when in operation, provides functions required for V2X broadcast. For example, the communication apparatus 600 may be a VRU-UE, and the circuitry 614 may, in operation, determine a periodic transmission time interval to transmit a first signal. The radio transmitter 602 may, in operation, transmits the first signal at the periodic transmission time interval in response to the determination of the circuitry 614.

The radio receiver 604, may, in operation, receives a second signal from the one or more other communication apparatuses within a pre-defined period; wherein the circuitry 614 is configured to determine whether to transmit the first signal further based on the second signal from the one or more other communication apparatuses.

The circuitry 614 may be further configured to calculate a first periodicity of the periodic transmission time interval based on a value of a multiplier parameter. The circuitry 614 may be further configured to increase the first periodicity of the periodic transmission time interval when the value of the multiplier parameter is larger.

The circuitry 614 may be further configured to calculate the first periodicity of the periodic transmission time interval based on a second periodicity of an operating cycle, wherein a portion of the operating cycle relates to an active time period during which the communication apparatus is active and the remaining portion of the operating cycle relates to an inactive time period during which the communication apparatus is inactive.

The circuitry 614 may be further configured to calculate the first periodicity of the periodic transmission time interval to be shorter than the second periodicity of the operating cycle when the value of the multiplier parameter is a specific value.

The circuitry 614 may be further configured to extend the active time period to the remaining portion of the operating cycle when the value of the multiplier parameter is a specific value such that the communication apparatus remains active throughout the operating cycle.

The circuitry 614 may be further configured to determine not to transmit the first signal when the value of the multiplier parameter is a specific value.

The circuitry 614 may be further configured to identify one danger level of a plurality of danger levels associated with the communication apparatus; and determine the value of the multiplier parameter corresponding to the one danger level.

The circuitry 614 may be further configured to calculate the periodicity of the periodic transmission time interval based on the one danger level of the plurality of danger levels.

The circuitry 614 may be further configured to shorten the periodicity of the periodic transmission time interval when the one danger level of the plurality of danger levels is determined to be high.

The circuitry 614 may be further configured to determine the danger level of the plurality of danger levels is based on a geographical zone identified based on a location of the communication apparatus. The circuitry 614 may be further configured to identify the geographical zone based on a Global Navigation Satellite System location of the communication apparatus and pre-loaded map data.

The circuitry 614 may be further configured to determine if the peer communication apparatus is in the geographical zone based on the second signal; and wherein, the circuitry determines not to transmit the first signal in response to the determination of the peer communication apparatus is in the geographical zone.

The circuitry 614 may be further configured to allocate a transmission duration and a receive duration within the active time period according to the one danger level of the plurality of danger levels associated with the communication apparatus.

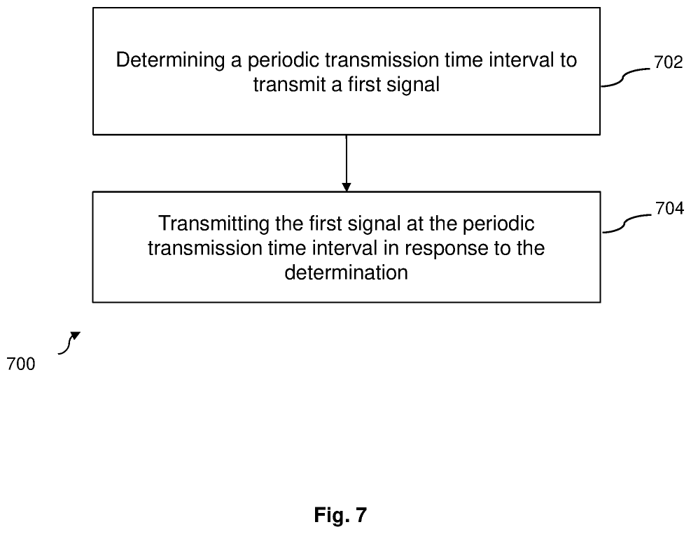

FIG. 7 shows a flow diagram illustrating a communication method 700 for vulnerable road users to transmit a first signal at a periodic transmission time interval in accordance with various embodiments of the present disclosure. In step 702, a step of determining a periodic transmission time interval to transmit a first signal is carried out. In step 704, a step of transmitting the first signal at the periodic transmission time interval in response to the determination.

According to the present disclosure, a SL broadcast signal is transmitted during DRX on-duration but may not be every DRX on-duration. In other words, the broadcast occasion should be aligned or near timing with a UE's DRX on-duration for power saving purposes. The SL broadcast periodicity can be same as or multiple DRX cycles.

To achieve so, a multiplier parameter, e.g. “drxCycleMultiplier” is configured to a VRU-UE and used to calculate the broadcast periodicity of the VRU-UE using the existing DRX cycles (shortDRX-Cycle or longDRX-cycle). In various embodiments of the present disclosure, the broadcast transmission periodicity can be calculated using equation (1) as shown below:

Broadcast periodicity=drxCycleMultiplier×longDRX-cycle equation (1)

For example, when the multiplier parameter “drxCycleMultiplier” has a value of 5 and the longDRX-cycle is 1280 ms, the VRU broadcast cycle has a periodicity of 6400 ms or 6.4 s. According to the various embodiments, when the “drxCycleMultiplier” multiplier parameter has a value of 1, the broadcast periodicity may be same as that of the DRX cycles, where a broadcast signal is transmitted in every DRX cycle during the DRX on-duration; when the “drxCycleMultiplier” multiplier parameter has a value of 5, the broadcast periodicity may be five DRX cycles, where a broadcast signal is transmitted after every five DRX cycles during the DRX on-duration of the fifth DRX cycle of the every five DRX cycles.

Note that the name of multiplier parameter, i.e. “drxCycleMultiplier”, is a non-limiting example. The multiplier parameter may can be used for other pre-defined mathematical operation such as addition, subtraction and division or other equation to calculate the broadcast periodicity. Different values of the multiplier parameters may correspond to different mathematical operations. For example, the value of the multiplier parameter “drxCycleMultiplier” of 2 may correspond to a mathematical operation of multiplying the longDRX-cycle by 5, while the value of multiplier parameter of 3 may correspond to another mathematical operation of dividing the longDRX-cycle by 3. In addition, the multiplier parameter can also be with RRC, MAC or PHY layer signalling.

According to various embodiments of the present disclosure, the multiplier parameter “drxCycleMultiplier” can be linked with danger levels associated with the communication apparatus. In an embodiment, danger level indicator “DangerZonelndicator” is used to indicate one danger level of a plurality of danger levels. The value of the multiplier parameter “drxCycleMultiplier” is then determined by the value of the danger level indicator “DangerZonelndicator”, and different values of the multiplier parameter “drxCycleMultiplier” may correspond to different values of the danger level indicator “DangerZonelndicator”. Note that the name of danger level indicator, i.e. “DangerZonelndicator”, is a non-limiting example.

The value of the danger level indicator may be in a range of 0 to 3 to indicate four different danger levels from most dangerous and safe respectively, and the value of the multiplier parameter “drxCycleMultiplier” corresponding to each of the four danger levels is as follows:
drxCycleMultiplier=1 for DangerZonelndicator=0 (most dangerous);
drxCycleMultiplier=2 for DangerZonelndicator=1 (dangerous);
drxCycleMultiplier=5 for DangerZonelndicator=2 (less dangerous); and
drxCycleMultiplier=10 for DangerZonelndicator=3 (safe).

In this example, the broadcast periodicity, when the danger level is safe, may be ten DRX cycles, where a broadcast signal is transmitted every ten DRX cycles; whereas the broadcast periodicity, when the danger level is dangerous, may be two DRX cycle, where a broadcast signal is transmitted every two DRX cycles.

According to another embodiment of the present disclosure, different power saving modes of a VRU-UE may be associated with different danger levels (e.g. values of the danger level indicator). In particular, the VRU-UE may be configured to enter a deep-sleep power saving mode when the danger level is determined to be low or safe (e.g. “DangerZonelndicator”=3); a light-sleep power saving mode when the danger level is determined to be moderate or (less) dangerous (e.g. “DangerZonelndicator”=1 or 2); and a micro-sleep power saving mode when the danger level is determined to be high or most dangerous (e.g. “DangerZonelndicator”=0).

In another embodiment, the multiplier parameter “drxCycleMultiplier” can be used to switch off SL broadcast. In particular, the VRU-UE may be configured to determine not transmit a SL broadcast signal when the value of the multiplier parameter “drxCycleMultiplier” is a specific value, for example when drxyCycleMultiplier=0, and/or when the value of the danger level indicator is a specific value, for example when DangerZonelndicator=3 (safe).

Yet in another embodiment, the multiplier parameter “drxCycleMultiplier” can be used to switch off DRX feature. In particular, the VRU-UE may be configured to extend DRX on-duration to the whole DRX cycle when the value of the multiplier parameter is a specific value, for example when drxCycleMultiplier=−1, and/or when the value of the danger level indicator is a specific value, for example when DangerZonelndicator=0 (most dangerous), such that the VRU-UE is always on or active.

In an embodiment, the multiplier parameter “drxCycleMultiplier” can be used to switch the broadcast periodicity to be shorter than the periodicity of the DRX cycles when the value of the multiplier parameter is a specific value, for example when drxCycleMultiplier=0.5, and/or when the value of the danger level indicator is a specific value, for example when DangerZonelndicator=1 (dangerous).

It is noted that potential collision issue may be caused by transmitting a broadcast signal at a periodic transmission interval at a periodicity that is shorter than that of the DRX cycles. However, this can be mitigated by the geolocation-based transmission and/or listen-before-talk (LBT) operations which will be further elaborated in the following.

In the following paragraphs, certain exemplifying embodiments are explained with reference to a VRU communications mechanism that advantageously performs an LBT-like operation in determining broadcast resources and occasions for VRUs.

Urban areas usually have a denser population, and many VRUs (e.g. pedestrians) may gather in business districts or commercial zones. As a result, there chance of traffic collision and huge waste of resource if all VRU-UEs wish to broadcast its presence.

A pre-defined period such as an LBT period can be designed for VRU-UEs for power saving and/or resource efficiency purpose. In particular, a VRU-UE may be configured to determine not to transmit its broadcast signal (e.g. safety message) or indicate its presence if a broadcast signal from other peer communication apparatus, i.e. other VRU-UE, close to the location of the VRU-UE is detected within the LBT period. Such LBT-like operation can be realized by higher layer (Operation A) or physical layer (Operation B).

A LBT period is a time period prior to a VRU-UE's broadcast occasion, during which the VRU-UE at a location is configured to receive SL transmission (e.g. broadcast signal) from a peer VRU-UE that is located close to its location and determine not to transmit its own broadcast signal based on the received SL transmission from the peer VRU-UE.

Regarding Operation A, a parameter “SL-LBTperiod” is (pre-)configured or predefined to a VRU-UE to indicate the LBT period. The VRU-UE would receive other UEs' SL transmission in its LBT period. The received SL transmission from other UEs will be decoded, and the decoding results are reported to higher layer (MAC or RRC) and the respective higher layer would then decide whether to perform the consequent SL broadcast. Note that the name of the parameter “SL-LBTperiod” is an example and is not limited to the name described.

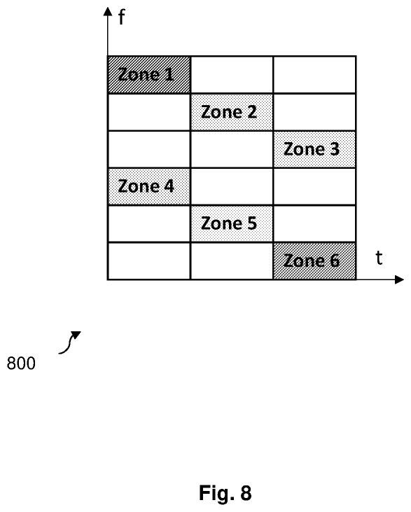

Regarding Operation B, for physical layer, geo-location/zone specific resources are (pre-)configured for different geographical zones. For example, FIG. 8 shows a resources map of six zone-specific resources configured for six different geographical zones 1-6 respectively. All VRU-UEs within a same geographical zone should use the same geo-location/zone specific resource to indicate its presence. In an embodiment, a geographical zone of a VRU-UE can be identified based on a Global Navigation Satellite System (GNSS) location of the VRU-UE and/or pre-loaded map data. In another embodiment, only 1-bit is carried by sequence in the zone-specific resource, and thus multiple UEs' transmission can be overlapped for vehicle UEs' reception and Physical Sidelink Feedback Channel (PSFCH) can be reused.

Under operation B, the LBT period is (pre-)configured or predefined. The LBT period could include the VRU-UE's last transmission occasion. The VRU-UE receives other UE's indication in the same geographical zone will not broadcast its present in the subsequent transmission occasions.

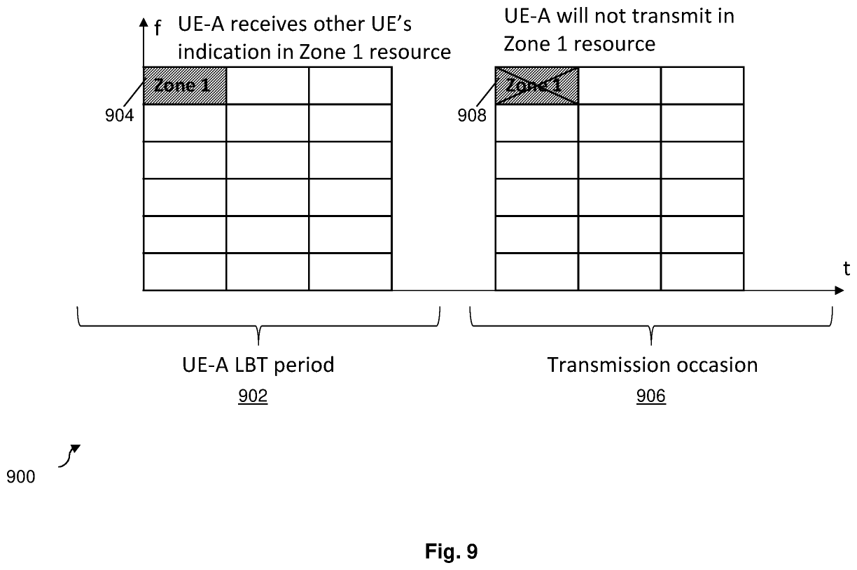

FIG. 9 depicts an example time diagram 900 illustrating an LBT period of a VRU-UE. An LBT period 902 may be configured prior to the periodic transmission time interval (e.g. transmission occasion) 906 of a VRU-UE, in this case UE-A, to transmit a signal to indicate its presence. Assuming UE-A is identified itself in zone 1 determined based on the location of UE-A, during the UE-A LBT period 902, UE-A may receive other UE's indication in Zone 1 resource 904 corresponding to the same geographical zone as UE-A. UE-A then determines not to transmit in Zone 1 resource and will not transmit in Zone 1 resource during its transmission occasion 906.

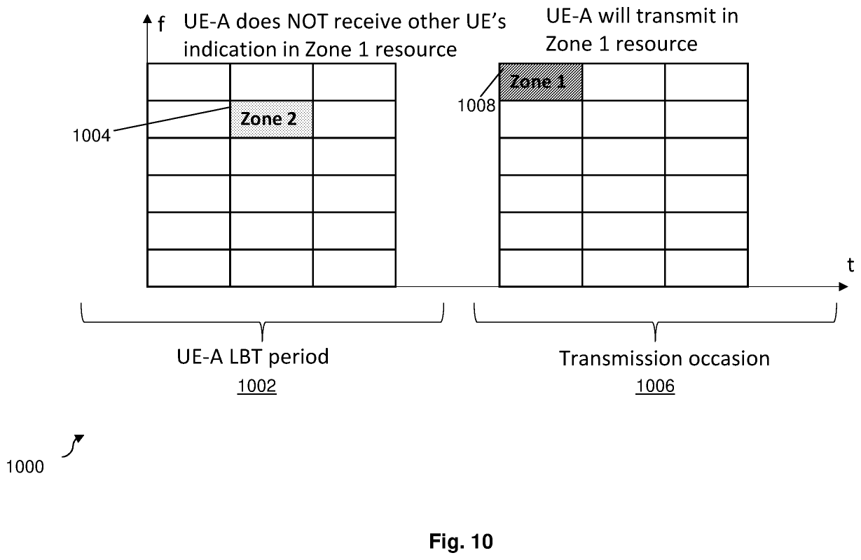

FIG. 10 depicts another example time diagram 1000 illustrating an LBT period of a VRU-UE. An LBT period 1002 may be configured prior to the periodic transmission time interval (e.g. transmission occasion) 906 of a VRU-UE, in this case UE-A, to transmit a signal to indicate its presence. Assuming UE-A identified itself to be in zone 1 determined based on the location of UE-A, during the UE-A LBT period 1002, UE-A may not receive any indication from other UE in Zone 1 resource, in this case only Zone 2 resource 1004 corresponding to a different geographical zone from that of UE-A is received from another UE, UE-A then determines to transmit Zone 1 resource during its transmission occasion 1006.

In various embodiments, the geographical zone can be flexible shape and (pre-) configured for different geographical features (e.g. rural, urban, roadside, junction, etc.) including altitude. The zone can be configured as rectangles according to Zone IDs (12 bits according to GNSS locations) which already defined by 3GPP.

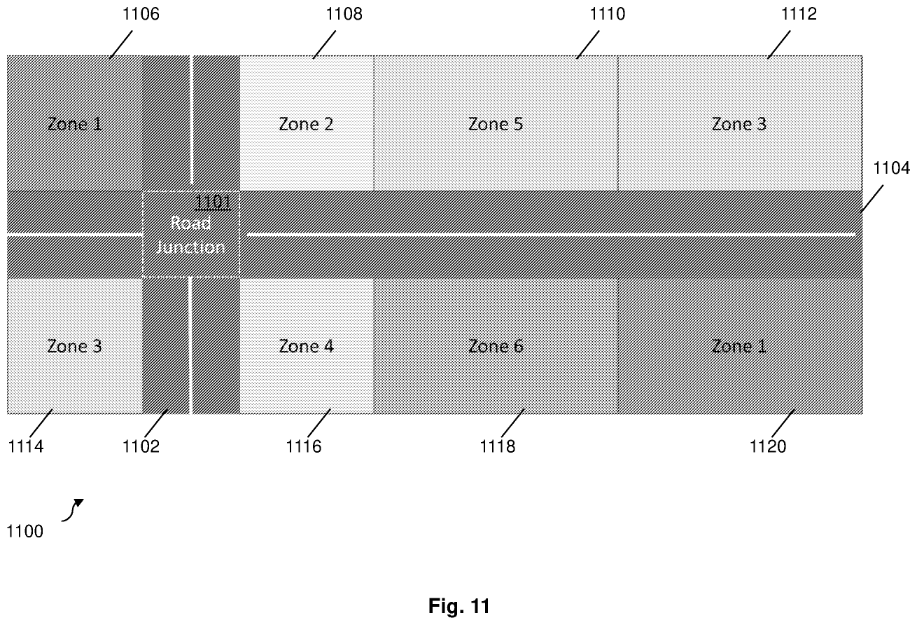

FIG. 11 illustrates a map of a road junction 1101, two roads 1102, 1104 forming the road junction 1101 and geographical areas 1106-1120 adjacent to the two roads according to an embodiment. The rectangular geographical areas 1106-1120 adjacent to the two roads 1102, 1104 forming the road junction 1101 may be configured according to Zone IDs according GNSS locations. Each of the geographical areas may be categorized into any one of geographical zones 1 to 6 (or 1 to 8 depending on implementation) based on the geographical features within the zone. Each of the geographical zones 1 to 6 may be further linked with a danger level. For example, danger level indicator “DangerZonelndicator” is used to indicate one danger level of a plurality of danger levels. Zone 1 to 4, e.g. areas 1106, 1108, 1112, 1114, 1116, 1120, may be associated with a value of the danger level indicator “DangerZonelndicator” of 0 indicating the VRU-UE is at a geographical zone with the most dangerous danger level, whereas Zone 5-8, e.g. areas 1110, 1118, may be associated with a value of the danger level indicator “DangerZonelndicator” of 2 indicating the VRU-UE is at a geographical zone with a less dangerous danger level.

In various embodiments of the present disclosure, such danger level (or the value of the danger level indicator “DangerZonelndicator”) is linked with the multiplier parameter (or the value of the multiplier parameter “drxCycleMultiplier”) which in turn used to determine the broadcast periodicity at which the VRU-UE used for transmitting its broadcast signal to indicate its presence.

In the following paragraphs, certain exemplifying embodiments are explained with reference to a dedicated broadcast resource that is specifically configured for VRU-UEs to transmit their broadcast signals.

Although both VRU-UE and vehicle UEs (V-UEs) are SL UEs, the VRU-UEs have totally different role from the V-UEs. The resource sharing between VRU-UEs and V-UEs would cause inefficient resource utilizations and undesirable in-air collisions. In particular, the VRU-UEs use cases are mostly for own safety while V-UEs have much more use cases.

Further, VRU-UEs are mostly powered by batteries and very power critical, which is different from V-UEs which are mostly powered by vehicle engines or bigger batteries for electric vehicles (EVs).

To address the above challenges, a dedicated resource pool consisting of a transmission resource pool (VRU-TxPool) and a receive resource pool (VRU-RxPool) is (pre-)configured for VRU-UEs, where VRU-TxPool is specially for VRU-UEs and not used by other SL UEs like V-UEs, while VRU-RxPool should be known to V-UEs, and SL message of the V-UEs is in the VRU resource pool if VRUs are the target receivers. According to various embodiments of the present disclosure, the resource pool can be aligned with VRU-UEs' DRX cycles for power saving purpose.

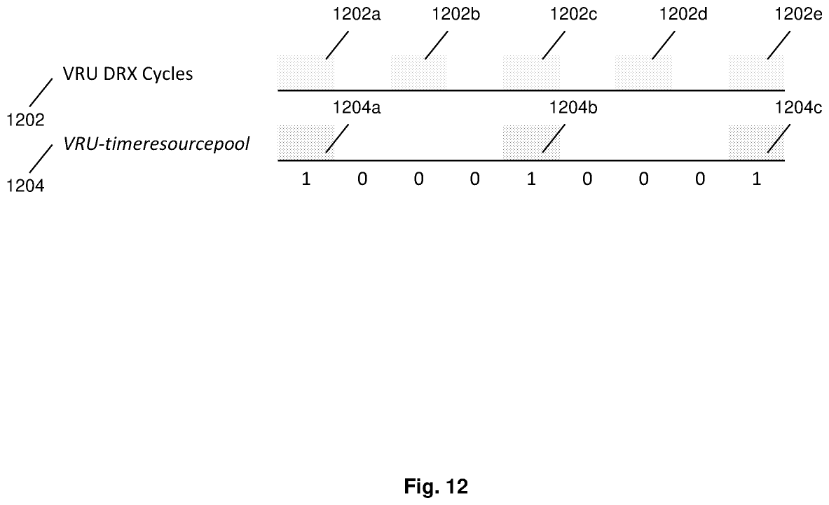

The resource pool is indicated by higher layer parameters relating to a time resource pool, e.g. VRU-timeresourcepool, and a frequency resource pool, e.g. VRU-frequencyresourcepool, for both VRU-TxPool and VRU-RxPool. According to the present disclosure, the VRU-timeresourcepool bitmaps for both VRU-TxPool and VRU-RxPool are within VRU-UE's active time period (e.g. wake up duration or DRX on-durations). In an embodiment, the time resource pool may be partly (near timing) or entirely aligned with the VRU-UE's active time period. FIG. 12 depicts an example time resource pool 1204 of a VRU-UE in relation to its DRX cycles 1202. In this example, the time resource pool 1204, e.g. 1204a, 1204b, 1204c, of the VRU-UE is aligned with the VRU-UE's DRX cycles, specifically the DRU-UE's on-durations in every two DRX cycles, e.g. 1202a, 1202c and 1202e.

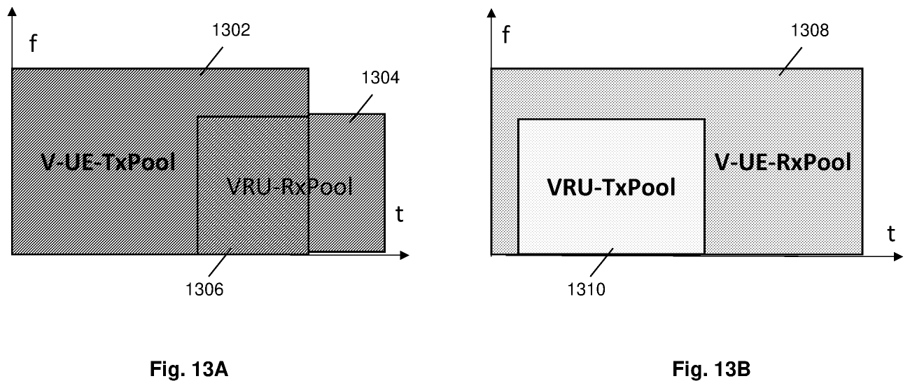

FIG. 13A depicts an example VRU-RxPool 1304 of a VRU-UE in relation to a transmission Tx pool of a V-UE (V-UE-TxPool) 1302 while FIG. 13B depicts an example VRU-TxPool 1310 of a VRU-UE in relation to a Rx resource pool of a V-UE (V-UE-RxPool) 1308. According to the present disclosure, a portion of the receive resource pool configured for VRU-UEs, e.g. VRU-RxPool 1304, overlaps with a portion of the transmission resource pool configured for the other SL UEs, e.g. V-UE-TxPool 1302. The V-UE may only send VRU-UE targeted message in the overlapped portion 1306 of the VRU-RxPool 1304 and V-UE-TxPool 1302.

The transmission resource pool configured for VRU-UEs, e.g. VRU-TxPool 1310, does not overlap with the transmission resource pool configured for another SL UEs like V-UEs, e.g. V-UE-TxPool 1302, but overlaps with the receive resource pool configured for the other SL UEs, e.g. V-UE-RxPool 1308. In particular, the V-UE-RxPool 1308 should cover all VRU-TxPool 1310.

It is noted that the respective blocks in FIGS. 13A and 13B used for illustrating the transmission and receive resource pools configured for the VRU-UEs and V-UEs, e.g. 1302, 1304, 1308, 1310, are for illustration purpose only. The actual resource pools may not be continuous and may be mapped into multiple blocks. It is further noted that the names of transmission resource pool “VRU-TxPool”, receive resource pool “VRU-RxPool”, time resource pool “VRU-timeresoucepool” and frequency resource pool “VRU-frequencypool” are non-limiting examples.

According to the present disclosure, the DRX cycles can be aligned for VRU-UEs as the periodic transmission time interval for transmitting its broadcast signal. There are some other features/properties can also be configured as part of resource pool configurations. In an embodiment, where the transmission time interval is aligned with the DRX on-duration, both SL Rx and TX durations can be allocated within the DRX on-duration.

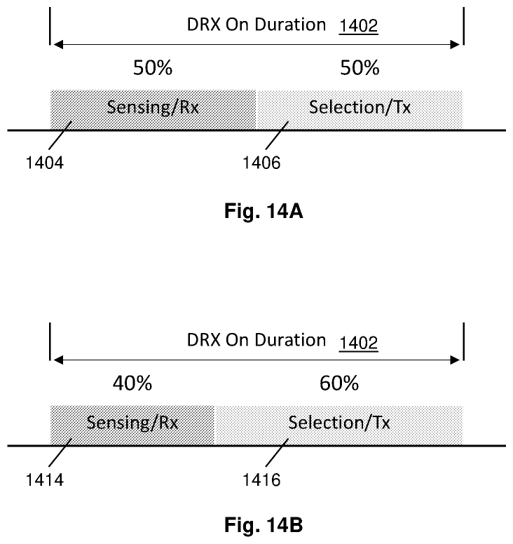

FIGS. 14A and 14B depict two configurations allocating a SL Rx duration and a SL Tx duration within a DRX on-duration according to an embodiment of the present disclosure. FIG. 14A depicts a first example configuration where 50% of the DRX on-duration 1402 is allocated to sensing/receive, as illustrated by time period 1404, and the remaining 50% of the DRX on-duration 1402 is allocated to selection/transmission, as illustrated by time period 1406. FIG. 14B depicts a second example configuration where 40% of the DRX on-duration 1402 is allocated to sensing/receive, as illustrated by time period 1414, and the remaining 60% of the DRX on-duration 1402 is allocated to selection/transmission, as illustrated by time period 1416.

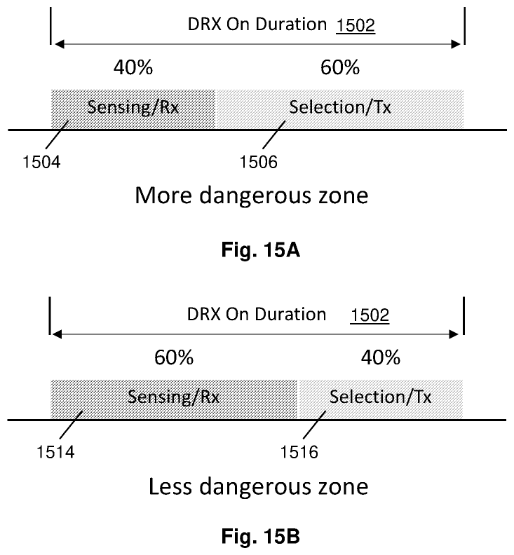

FIGS. 15A and 15B depicts two configurations allocating a SL Rx duration and a SL Tx duration within a DRX on-duration according to another embodiment of the present disclosure. In this embodiment, the SL Rx and TX durations within the DRX on-duration can be dynamically allocated, for example according to danger levels (or values of the danger level indicator “DangerZonelndicator”) and/or geographical zones. For example, in FIG. 15A, when a VRU-UE is identified to be in a geographical zone associating with a more dangerous danger level (e.g. danger level indicator value of 1), 40% of the DRX on-duration 1502 is allocated to sensing/receive, as illustrated by time period 1504, and the remaining 60% of the DRX on-duration 1502 is allocated to selection/transmission, as illustrated by time period 1506. For example, subsequently, in FIG. 15B, when it is identified the VRU-UE is identified to be in a geographical zone associated with a less dangerous danger level (e.g. danger level indicator value of 2), the allocation of the SL Rx and Tx durations may change such that 60% of the DRX on-duration 1502 is now allocated to sensing/receive, as illustrated by time period 1514, and the remaining 40% of the DRX on-duration 1502 is allocated to selection/transmission, as illustrated by time period 1516.

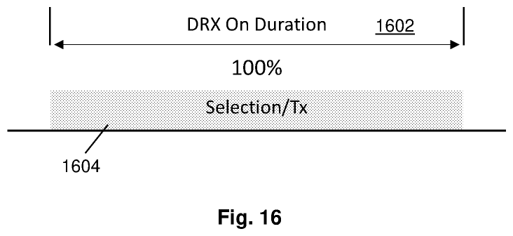

Yet in another embodiment, “no-sensing” or “partial-sensing” can be within the resource pool's property, FIG. 16 depicts a configuration allocating only a SL Tx duration 1604 within a DRX on-duration 1602. In this embodiment, the entire DRX on-duration 1602 is configured for selection/transmission, as illustrated by time period 1604, without a SL Rx period for sensing/receive, and as a result, the VRU-UE does not perform SL Rx during the DRX on-duration 1602.

It is further noted that the sum of the percentages of the Rx duration and Tx duration (e.g. 50%-50% or 40%-60% above) occupying the DRX on-duration may not be 100%. The Rx duration and Tx duration may not occupy the entire DRX on-duration (e.g. with Connected mode DRX) and thus the sum of the Rx duration percentage and Tx duration is less than 100%. On the other hand, the sum of the percentages of the Rx duration and Tx duration may be more than 100%, for example with DRX inactivity timer exceeding the DRX on-duration.

In the following paragraphs, certain exemplifying embodiments are explained with reference to terms related to 5G core network and the present disclosure regarding communication apparatuses and methods for sidelink broadcast, namely:

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuitry, which in operation, determines a periodic transmission time interval to transmit a first signal; and
a transmitter, which in operation, transmits the first signal at the periodic transmission time interval in response to the determination.

2. The communication apparatus of claim 1, wherein the circuitry is further configured to calculate a first periodicity of the periodic transmission time interval based on a value of a multiplier parameter.

3. The communication apparatus of claim 2, wherein the circuitry is further configured to increase the first periodicity of the periodic transmission time interval when the value of the multiplier parameter is larger.

4. The communication apparatus of any one of claims 2 and 3, wherein the circuitry is further configured to calculate the first periodicity of the periodic transmission time interval based on a second periodicity of an operating cycle, wherein a portion of the operating cycle relates to an active time period during which the communication apparatus is active and the remaining portion of the operating cycle relates to an inactive time period during which the communication apparatus is inactive.

5. The communication apparatus of claim 4, wherein the circuitry is further configured to calculate the first periodicity of the periodic transmission time interval to be shorter than the second periodicity of the operating cycle when the value of the multiplier parameter is a specific value.

6. The communication apparatus of claim 4, wherein the circuitry is further configured to extend the active time period to the remaining portion of the operating cycle when the value of the multiplier parameter is a specific value such that the communication apparatus remains active throughout the operating cycle.

7. The communication apparatus of claim 2, wherein the circuitry is further configured to determine not to transmit the first signal when the value of the multiplier parameter is a specific value.

8. The communication apparatus of any one of claims 4 to 6, wherein the circuitry is further configured to: identify one danger level of a plurality of danger levels associated with the communication apparatus; and determine the value of the multiplier parameter corresponding to the one danger level.

9. The communication apparatus of claim 8, wherein the circuitry is further configured to calculate the periodicity of the periodic transmission time interval based on the one danger level of the plurality of danger levels.

10. The communication apparatus of claim 9, wherein the circuitry is further configured to shorten the periodicity of the periodic transmission time interval when the one danger level of the plurality of danger levels is determined to be high.

11. The communication apparatus of any one of claims 9 and 10, wherein the circuitry is further configured to determine the danger level of the plurality of danger levels is based on a geographical zone identified based on a location of the communication apparatus.

12. The communication apparatus of claim 11, wherein the circuitry is further configured to identify the geographical zone based on a Global Navigation Satellite System location of the communication apparatus and pre-loaded map data.

13. The communication apparatus according to any one of claims 8 to 12, further comprising: a receiver, which in operation, receives a second signal from a peer communication apparatus within a pre-defined period; wherein the circuitry is configured to determine whether to transmit the first signal further based on the second signal from the peer communication apparatus.

14. The communication apparatus according to claim 13, wherein the circuitry is further configured to: determine if the peer communication apparatus is in the geographical zone based on the second signal; and wherein, the circuitry determines not to transmit the first signal in response to the determination of the peer communication apparatus is in the geographical zone.

15. The communication apparatus of any one of claims 8 to 12, wherein a resource pool, comprising a transmission resource pool and a receive resource pool, is specifically configured for the communication apparatus.

16. The communication apparatus of claim 15, wherein the transmission resource pool does not overlap with another transmission resource pool configured for another communication apparatus.

17. The communication apparatus of claim 16, wherein the transmission resource pool overlaps with another receive resource pool configured for the another communication apparatus.

18. The communication apparatus of any one of claims 16 and 17, wherein a portion of the receive resource pool overlaps with a portion of the another transmission pool configured for the another communication apparatus.

19. The communication apparatus of claim 18, further comprising:
a receiver, which in operation, receives a third signal from the another communication apparatus through the portion of the receive resource pool.

20. The communication apparatus of any one of claims 15 to 19, wherein a time resource pool, which indicates the transmission resource pool and the receive resource pool, is partly or entirely aligned the active time period.

21. The communication apparatus of claim 20, wherein the circuitry is further configured to allocate a transmission duration and a receive duration within the active time period according to the one danger level of the plurality of danger levels associated with the communication apparatus.

22. The communication apparatus of claim 21, wherein the transmission duration is positively correlated with the danger level of the plurality of danger levels; whereas the receive duration is negatively correlated with the danger level of the plurality of danger levels.

23. A communication method comprising:
determining a periodic transmission time interval to transmit a first signal; and
transmitting the first signal at the periodic transmission time interval in response to the determination.

1-16. (canceled)

17. A communication apparatus comprising:
circuitry, which in operation, determines a periodic transmission time interval to transmit a first signal; and
a transmitter, which in operation, transmits the first signal at the periodic transmission time interval in response to the determination.

18. The communication apparatus of claim 17, wherein the circuitry is further configured to calculate a first periodicity of the periodic transmission time interval based on a value of a multiplier parameter.

19. The communication apparatus of claim 18, wherein the circuitry is further configured to increase the first periodicity of the periodic transmission time interval when the value of the multiplier parameter is larger.

20. The communication apparatus of claim 18, wherein the circuitry is further configured to determine not to transmit the first signal when the value of the multiplier parameter is a specific value.

21. The communication apparatus of claim 18, wherein the circuitry is further configured to calculate the first periodicity of the periodic transmission time interval based on a second periodicity of an operating cycle, wherein a portion of the operating cycle relates to an active time period during which the communication apparatus is active and the remaining portion of the operating cycle relates to an inactive time period during which the communication apparatus is inactive.

22. The communication apparatus of claim 21, wherein the circuitry is further configured to calculate the first periodicity of the periodic transmission time interval to be shorter than the second periodicity of the operating cycle when the value of the multiplier parameter is a specific value.

23. The communication apparatus of claim 21, wherein the circuitry is further configured to extend the active time period to the remaining portion of the operating cycle when the value of the multiplier parameter is a specific value such that the communication apparatus remains active throughout the operating cycle.

24. The communication apparatus of claim 21, wherein the circuitry is further configured to:
identify one danger level of a plurality of danger levels associated with the communication apparatus; and
determine the value of the multiplier parameter corresponding to the one danger level.

25. The communication apparatus of claim 24, wherein the circuitry is further configured to calculate the periodicity of the periodic transmission time interval based on the one danger level of the plurality of danger levels.

26. The communication apparatus of claim 25, wherein the circuitry is further configured to shorten the periodicity of the periodic transmission time interval when the one danger level of the plurality of danger levels is determined to be high.

27. The communication apparatus of claim 25, wherein the circuitry is further configured to determine the danger level of the plurality of danger levels is based on a geographical zone identified based on a location of the communication apparatus.

28. The communication apparatus of claim 27, wherein the circuitry is further configured to identify the geographical zone based on a Global Navigation Satellite System location of the communication apparatus and pre-loaded map data.

29. The communication apparatus of claim 24, further comprising:
a receiver, which in operation, receives a second signal from a peer communication apparatus within a pre-defined period;
wherein the circuitry is configured to determine whether to transmit the first signal further based on the second signal from the peer communication apparatus.

30. The communication apparatus of claim 29, wherein the circuitry is further configured to:
determine if the peer communication apparatus is in the geographical zone based on the second signal; and
wherein, the circuitry determines not to transmit the first signal in response to the determination of the peer communication apparatus is in the geographical zone.

31. The communication apparatus of claim 24, wherein a resource pool, comprising a transmission resource pool and a receive resource pool, is specifically configured for the communication apparatus.

32. The communication apparatus of claim 31, wherein the transmission resource pool does not overlap with another transmission resource pool configured for another communication apparatus.

33. The communication apparatus of claim 32, wherein the transmission resource pool overlaps with another receive resource pool configured for the another communication apparatus.

34. The communication apparatus of claim 32, wherein a portion of the receive resource pool overlaps with a portion of the another transmission pool configured for the another communication apparatus.

35. The communication apparatus of claim 34, further comprising:
a receiver, which in operation, receives a third signal from the another communication apparatus through the portion of the receive resource pool.

36. The communication apparatus of claim 31, wherein a time resource pool, which indicates the transmission resource pool and the receive resource pool, is partly or entirely aligned the active time period.

37. The communication apparatus of claim 36, wherein the circuitry is further configured to allocate a transmission duration and a receive duration within the active time period according to the one danger level of the plurality of danger levels associated with the communication apparatus.

38. The communication apparatus of claim 37, wherein the transmission duration is positively correlated with the danger level of the plurality of danger levels; whereas the receive duration is negatively correlated with the danger level of the plurality of danger levels.

39. A communication method comprising:
determining a periodic transmission time interval to transmit a first signal; and
transmitting the first signal at the periodic transmission time interval in response to the determination.
